(19) United States
(12) Patent Application Publication
(10) Pub. No.: US 2026/0100588 A1
(43) Pub. Date: Apr. 9, 2026

(54) Grid-Forming Microinverter and Method Based on Bidirectional Flyback Converters

(71) Applicant: Guizhou Power Grid Co., Ltd., Guiyang (CN)

(72) Inventors: Yu WANG, Guiyang (CN); Bowen LI, Guiyang (CN); Tingyun GU, Guiyang (CN); Yumin HE, Guiyang (CN); Mingyong XIN, Guiyang (CN); Jianyang ZHU, Guiyang (CN); Changbao XU, Guiyang (CN); Chenghui LIN, Guiyang (CN); Qiang FAN, Guiyang (CN); Li ZHANG, Guiyang (CN); Qihui FENG, Guiyang (CN); Houyi ZHANG, Guiyang (CN); Junyi MAO, Guiyang (CN); Bin LIU, Guiyang (CN); Yang WANG, Guiyang (CN); Qiji DAI, Guiyang (CN); Dunhui CHEN, Guiyang (CN); Yuanyuan ZHANG, Guiyang (CN); Bo ZHANG, Guiyang (CN); Fan XIE, Guiyang (CN)

(21) Appl. No.: 19/405,901

(22) Filed: Dec. 2, 2025

Related U.S. Application Data
(63) Continuation of application No. PCT/CN2024/115175, filed on Aug. 28, 2024.

(30) Foreign Application Priority Data
Jan. 30, 2024 (CN) 202410124531.5

(51) Int. Cl. H02J 3/44; H02J 3/1842; H02J 3/48; H02J 3/50; H02J 101/24; H02M 3/335

(52) U.S. Cl. CPC H02J 3/44; H02J 3/1842; H02J 3/48; H02J 3/50; H02M 3/33584; H02J 2101/24

(57) ABSTRACT

Disclosed in the present disclosure is a grid-forming microinverter and method based on bidirectional flyback converters, relating to the technical field of photovoltaic power generation. The method includes: calculating active power and reactive power through an output voltage and an output current of the grid-forming microinverter; generating a reference signal of a voltage loop by using a preset power reference value based on a power loop control principle; generating a reference signal of a peak current control loop according to an actual output voltage; and generating, according to primary-side current signals of the first bidirectional flyback converter and the second bidirectional flyback converter, a drive signal for each switch tube under regulation of the peak current control loop.

### CROSS-REFERENCE TO RELATED APPLICATIONS

The present application is a continuation of International Application No. PCT/CN2024/115175, filed on Aug. 28, 2024, which claims priority to Chinese Patent Application No. 202410124531.5, filed on Jan. 30, 2024, the entire disclosure of which is incorporated herein by reference.

### TECHNICAL FIELD

The present disclosure relates to the technical field of photovoltaic power generation, in particular to a grid-forming microinverter and method based on bidirectional flyback converters.

### BACKGROUND

Currently, in the technical field of distributed photovoltaic power generation, using dedicated photovoltaic grid-connected microinverters to connect each photovoltaic module to a power grid has become a popular trend. These microinverters have the advantages of small capacity, high efficiency, and easy installation, and are particularly suitable for small-scale residential distributed photovoltaic power generation scenarios. However, with the integration of a high proportion of new energy power generation systems into the power grid and the increasing penetration rate of power electronic devices themselves into the power grid, modern power grids have gradually exhibited weak grid characteristics, which puts forward higher requirements for the microinverters.

Traditional microinverters usually adopt unidirectional two-stage flyback inverters, which only allow one-way power flow. However, in modern power grids, especially in weak grid environments, such two-stage inverters have some problems. First, they usually adopt a phase-locked loop to obtain a voltage phase of the power grid for synchronization, but in weak grid environments, the stability of a phase-locked loop link may be affected. Second, the traditional microinverters operating in a unity power factor output mode cannot provide reactive power support for the power grid, so they are prone to faults of off-grid operation or islanding operation in weak grid environments. Moreover, the traditional two-stage topological structure also imposes some limitations on conversion efficiency of the microinverters.

Therefore, in order to adapt to the weak grid characteristics of modern power grids, the technology of photovoltaic grid-connected microinverters urgently needs optimization and improvement. The stability issue of the phase-locked loop needs to be solved, and the microinverters need to have a capability of bidirectional power flow, so as to provide reactive power support for the power grid. Furthermore, the topological structure of the microinverters also needs to be optimized to improve their conversion efficiency. Through these improvements, it is possible to better address the challenges brought by the grid connection of new energy power generation with a high penetration rate and the integration of power electronic devices with a high proportion.

### SUMMARY

The present disclosure is proposed in view of problems existing in phase-locked loop stability and power flow capability of existing microinverters.

Accordingly, the problem to be solved by the present disclosure lies in how to improve the stability of the microinverters and enable the microinverters to have an ability of bidirectional power flow.

To solve the above technical problems, the present disclosure provides the following technical solutions:

In a first aspect, examples of the present disclosure provide a grid-forming microinverter method based on bidirectional flyback converters. The method includes the bidirectional flyback converters and a grid-forming microinverter. The grid-forming microinverter includes a power loop, a voltage loop, and a peak current control loop. The method includes: calculating active power and reactive power through an output voltage and an output current of the grid-forming microinverter; generating a reference signal of the voltage loop by using a preset power reference value based on control of the power loop; generating a reference signal of the peak current control loop under control of the voltage loop according to an actual output voltage; and generating, according to primary-side current signals of the first bidirectional flyback converter and the second bidirectional flyback converter, a drive signal for each switch tube under regulation of the peak current control loop.

As a preferred solution of the grid-forming microinverter method based on bidirectional flyback converters in the present disclosure, the generating a reference signal of the voltage loop by using a preset power reference value includes: obtaining, by the voltage loop, a voltage error signal by comparing a voltage reference value generated by the power loop with the actual output voltage; processing the obtained voltage error signal by a proportional-integral-derivative (PID) controller, and generating a primary-side current reference signal of the peak current control loop; comparing, by the peak current control loop, the primary-side current reference signal generated by the voltage loop with the primary-side current signals of the first bidirectional flyback converter and the second bidirectional flyback converter; turning off primary-side switch tubes of the first bidirectional flyback converter and the second bidirectional flyback converter in a case where the primary-side current signals of the first bidirectional flyback converter and the second bidirectional flyback converter are greater than or equal to primary-side current reference signals of the first bidirectional flyback converter and the second bidirectional flyback converter; turning on the primary-side switch tubes of the first bidirectional flyback converter and the second bidirectional flyback converter in a case where the primary-side current signals of the first bidirectional flyback converter and the second bidirectional flyback converter are less than the primary-side current reference signals of the first bidirectional flyback converter and the second bidirectional flyback converter, to generate the drive signals for the switch tubes of the first bidirectional flyback converter and the second bidirectional flyback converter; and generating, by the grid-forming microinverter, a voltage phase of a power grid through a power control loop, to achieve synchronization between the microinverter and the power grid, and guarantee stable operation of a system.

As a preferred solution of the grid-forming microinverter method based on bidirectional flyback converters in the present disclosure, the power loop includes an active power-frequency droop link and a reactive power-voltage droop link, and a related formula is as follows:

$$\{ \begin{matrix}{ω}_{ref} - ω = {n}_{p} ( {P}_{ref} - {p}_{e} ) \\ {U}_{ref} - {U}_{0} = {n}_{q} ( {Q}_{ref} - {q}_{e} ) \\ {u}_{ref} = \sqrt{2} {U}_{0} cos ( ω t )\end{matrix}$$

where nₚ is an active power droop coefficient, n_{q} is a reactive power droop coefficient, ω_{ref} is a reference value of an output voltage frequency of the microinverter, ω is the output voltage frequency of the microinverter, P_{ref} and Q_{ref} are preset power reference values, pₑ is the output active power of the microinverter, u_{ref} is a reference voltage of the voltage loop, U_{ref} is a reference voltage amplitude value of the voltage loop, U₀ is the output voltage of the grid-forming microinverter, qₑ is the output reactive power of the microinverter, and t is time.

As a preferred solution of the grid-forming microinverter method based on bidirectional flyback converters in the present disclosure, the generating, according to primary-side current signals of the first bidirectional flyback converter and the second bidirectional flyback converter, a drive signal for each switch tube under regulation of the peak current control loop includes: making the first bidirectional flyback converter and the second bidirectional flyback converter work in an inductive current continuous mode; dividing, in a case where the first bidirectional flyback converter works, a circuit into a mode I and a mode II according to an off state of the third switch tube and an off state of the sixth switch tube; and dividing, in a case where the second bidirectional flyback converter works, the circuit into a mode III and a mode IV according to the off state of the sixth switch tube and an on state of the third switch tube.

As a preferred solution of the grid-forming microinverter method based on bidirectional flyback converters in the present disclosure, a relevant formula of the mode I is as follows:

$${i}_{1 m} = \frac{{U}_{DC}}{{L}_{m 1}} {T}_{1} + {i}_{10}$$

where Lₘ₁ is an inductance value of a primary winding of a first flyback transformer, i₁₀ is an initial value of a primary-side current of the first flyback transformer, T₁ is a turn-on time length of a primary-side switch tube of the first bidirectional flyback transformer in one switching cycle, U_{DC} is a direct-current input voltage, and i₁ₘ is a current peak value of the primary-side current of the first flyback transformer in one switching cycle.

A related formula of the mode II is as follows:

$${i}_{2 m} = {i}_{20} - \frac{{u}_{o}}{{L}_{m 2}} {T}_{2}$$

where Lₘ₂ is an inductance value of a secondary winding of the first flyback transformer, i₂₀ is an initial value of a secondary-side current of the first flyback transformer, T₂ is a turn-off time length of the primary-side switch tube of the first bidirectional flyback transformer in one switching cycle, u₀ is the actual output voltage, and i₂ₘ is a current peak value of a secondary-side current of the first flyback transformer in one switching cycle.

The present disclosure has the beneficial effects that synchronization of the inverter and the power grid is directly implemented through the power loop, such that a phase locked loop link required by a traditional microinverter is omitted. This innovation not only reduces control complexity, but also solves a problem that the traditional microinverter cannot operate stably in a weak grid environment, and improves the stability of the inverter. Moreover, grid-forming control is used, the active power, the reactive power, and a power factor output by the grid-forming microinverter are adjusted according to a dispatching command of the power grid, to provide active power support and reactive power support for the power grid. A deficiency that the traditional microinverter can only output active power and cannot provide reactive power support is overcome.

In a second aspect, the examples of the present disclosure provide a grid-forming microinverter based on bidirectional flyback converters. The grid-forming microinverter includes a photovoltaic direct-current input source, an input filter capacitor, a first bidirectional flyback transformer, a second bidirectional flyback transformer, a first switch tube, a second switch tube, a third switch tube, a fourth switch tube, a fifth switch tube, a sixth switch tube, a first output capacitor, a second output capacitor, a first output filter inductor, a second output filter inductor, a first output filter capacitor, a second output filter capacitor, a grid-side inductor, an equivalent power grid, and the grid-forming microinverter.

As a preferred solution of the grid-forming microinverter based on bidirectional flyback converters in the present disclosure, a positive terminal of the input filter capacitor is electrically connected to a positive terminal of the photovoltaic direct-current input source, a primary side of the first bidirectional flyback transformer, and a primary side of the second bidirectional flyback transformer. A negative terminal of the input filter capacitor is electrically connected to a negative terminal of the direct-current input source, a source of the first switch tube, and a source of the fourth switch tube. The other end of the primary side of the first bidirectional flyback transformer is electrically connected to a drain of the first switch tube. One end of a secondary side of the first bidirectional flyback transformer is electrically connected to a source of the second switch tube. The other end of the secondary side of the first bidirectional flyback transformer is electrically connected to a source of the third switch tube, a negative terminal of the first output capacitor, and a negative terminal of the first output filter capacitor. The source of the second switch tube is electrically connected to the source of the third switch tube, a positive terminal of the first output capacitor, and one end of the first output filter inductor. The other end of the first output filter inductor is electrically connected to a positive terminal of the first output filter capacitor and one end of the grid-side inductor. The other end of the grid-side inductor is electrically connected to one end of the equivalent power grid.

As a preferred solution of the grid-forming microinverter based on bidirectional flyback converters in the present disclosure, the other end of the primary side of the second bidirectional flyback transformer is electrically connected to a drain of the fourth switch tube. One end of a secondary side of the second bidirectional flyback transformer is electrically connected to a source of the fifth switch tube. The other end of the secondary side of the second bidirectional flyback transformer is electrically connected to a source of the sixth switch tube, a negative terminal of the second output capacitor, and a negative terminal of the second output filter capacitor. The source of the fifth switch tube is electrically connected to the source of the sixth switch tube, a positive terminal of the second output capacitor, and one end of the second output filter inductor. The other end of the second output filter inductor is electrically connected to a positive terminal of the second output filter capacitor and the other end of the equivalent power grid.

As a preferred solution of the grid-forming microinverter based on bidirectional flyback converters in the present disclosure, a drive signal of the first switch tube and drive signals of the second switch tube, the fourth switch tube, the fifth switch tube, the third switch tube, and the sixth switch tube are complementary separately.

As a preferred solution of the grid-forming microinverter based on bidirectional flyback converters in the present disclosure, working states of the first bidirectional flyback converter and the second bidirectional flyback converter are completely symmetrical. The first bidirectional flyback converter works in a positive half cycle of a voltage of a power grid. The second bidirectional flyback converter works in a negative half cycle of the voltage of the power grid.

In a third aspect, the examples of the present disclosure provide a computer device. The computer device includes a memory and a processor. The memory stores a computer program. Computer program instructions, when executed by the processor, implement steps of the grid-forming microinverter method based on bidirectional flyback converters according to the first aspect of the present disclosure.

In a fourth aspect, the examples of the present disclosure provide a computer-readable storage medium, storing a computer program. Computer program instructions, when executed by the processor, implement steps of the grid-forming microinverter method based on bidirectional flyback converters according to the first aspect of the present disclosure.

The present disclosure has the beneficial effects that a single-stage topology is adopted, and a traditional two-stage microinverter is simplified into a single-stage microinverter, the cost is saved, such that transmission efficiency of a system is improved. A topology of a bidirectional structure is adopted, bidirectional flow of power is supported, and a defect of unidirectional flow of energy of the traditional microinverter is overcome. A topological structure is simple, cost is low, efficiency is high, and control complexity is low.

### BRIEF DESCRIPTION OF DRAWINGS

In order to describe the technical solutions in examples of the present disclosure more clearly, the accompanying drawings required for describing the examples are briefly described below. Obviously, the accompanying drawings in the following description are merely some examples of the present disclosure. Those of ordinary skill in the art can also derive other accompanying drawings from these accompanying drawings without creative efforts. In the figures:

FIG. 1 is a structural diagram of a circuit of a grid-forming microinverter based on bidirectional flyback converters according to Example 1;

FIG. 2 is a control block diagram of a grid-forming microinverter based on bidirectional flyback converters according to Example 1;

FIG. 3 shows a primary-side current waveform of a grid-forming microinverter based on bidirectional flyback converters according to Example 1;

FIG. 4 is a drive signal diagram of a grid-forming microinverter based on bidirectional flyback converters according to Example 1;

FIG. 5 shows a grid-forming microinverter based on bidirectional flyback converters according to Example 1;

FIG. 6 is a working mode diagram of mode I of a grid-forming microinverter based on bidirectional flyback converters according to Example 1;

FIG. 7 is a working mode diagram of mode II of a grid-forming microinverter based on bidirectional flyback converters according to Example 1;

FIG. 8 is a working mode diagram of mode III of a grid-forming microinverter based on bidirectional flyback converters according to Example 1;

FIG. 9 is a working mode diagram of mode IV of a grid-forming microinverter based on bidirectional flyback converters according to Example 1;

FIG. 10 shows a steady-state output waveform of a grid-forming microinverter based on bidirectional flyback converters when a leading power factor is output according to Example 2;

FIG. 11 shows droop characteristic curves of output power of a grid-forming microinverter based on bidirectional flyback converters according to Example 2;

FIG. 12 shows simulation waveforms of output leading power factors of a grid-forming microinverter based on bidirectional flyback converters according to Example 2;

FIG. 13 shows simulation waveforms of an output voltage and current of a grid-forming microinverter based on bidirectional flyback converters at a hysteresis power factor according to Example 2; and

FIG. 14 shows simulation waveforms of active power and a frequency phase of a grid-forming microinverter based on bidirectional flyback converters in Example 2.

### DETAILED DESCRIPTION OF THE EMBODIMENTS

In order to make the above objectives, features, and advantages of the present disclosure clearer and more understandable, particular embodiments of the present disclosure will be described in detail below in conjunction with the accompanying drawings of the description.

In the following description, numerous concrete details are set forth in order to provide a thorough understanding of the present disclosure. However, the present disclosure may be implemented otherwise than as specifically described herein. Those skilled in the art can make similar developments without departing from the spirit of the present disclosure, and therefore the present disclosure is not to be limited by the specific examples disclosed below.

Secondly, reference herein to “an example” or “example” means a specific feature, structure, or characteristic that can be included in at least one embodiment of the present disclosure. The phase “in an example” at different places in the present description neither refers to the same example, nor is a separate or selective example mutually exclusive of other examples.

### Example 1

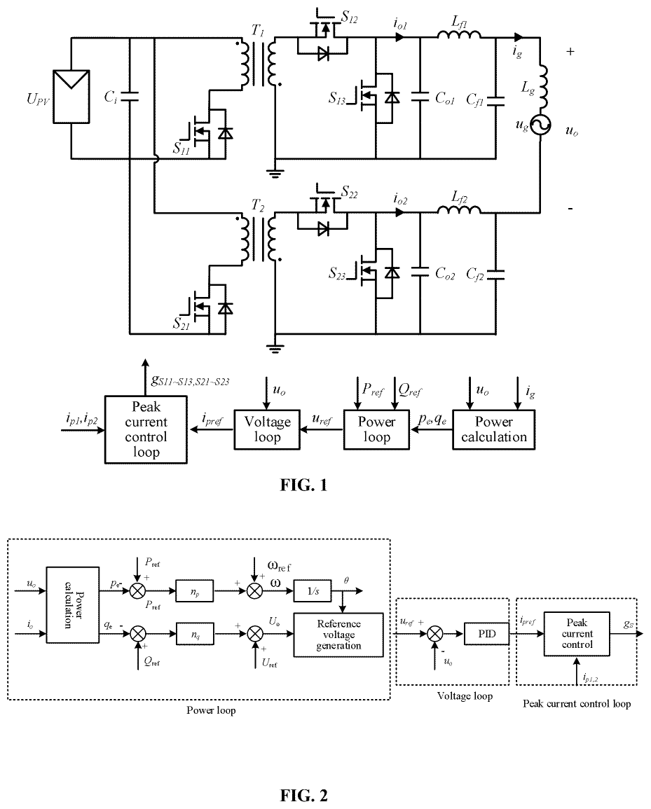

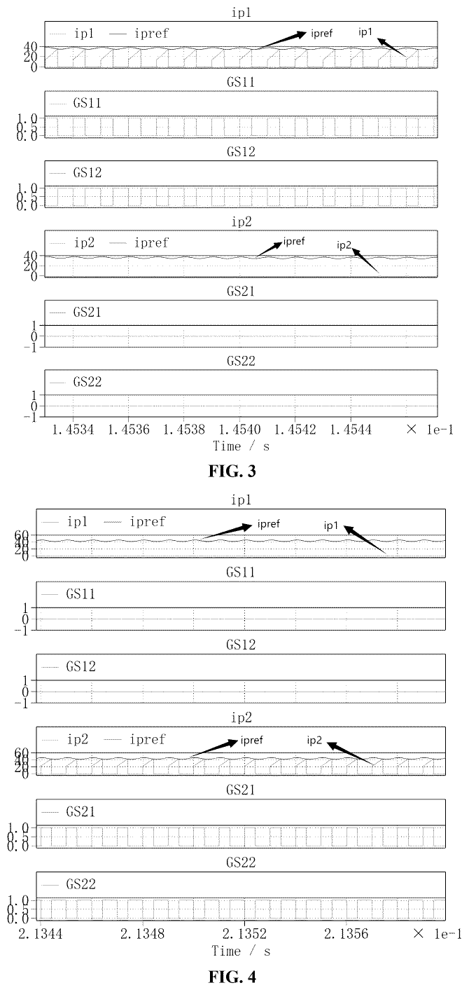

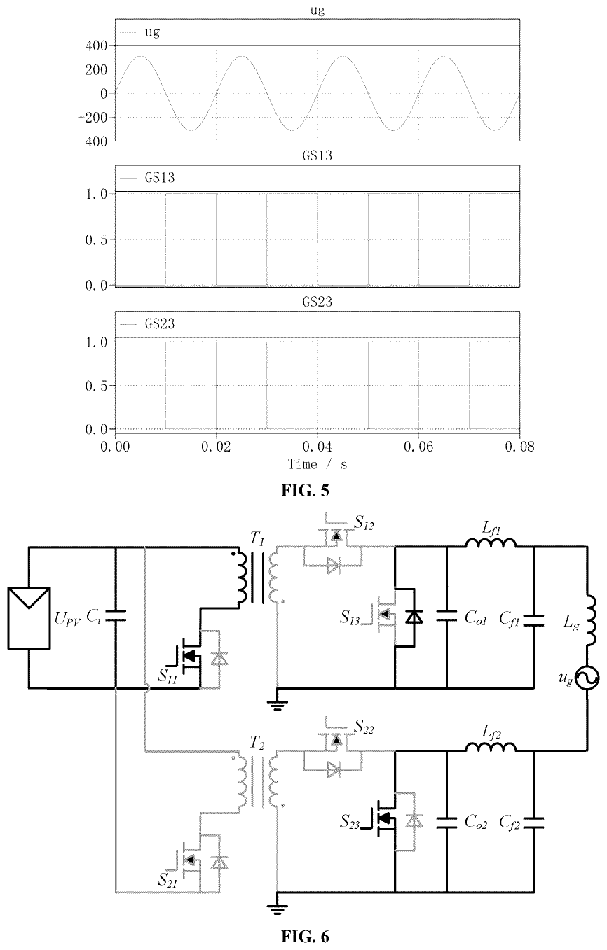

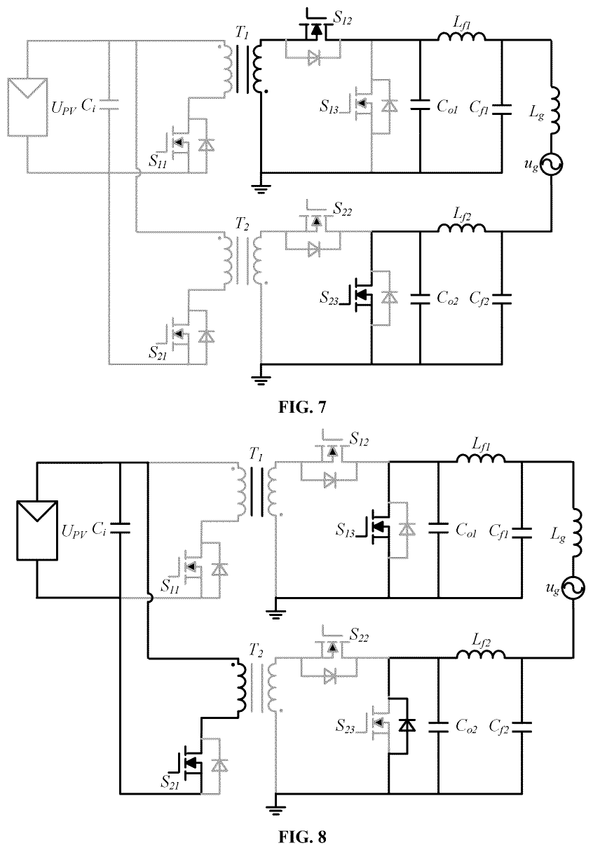

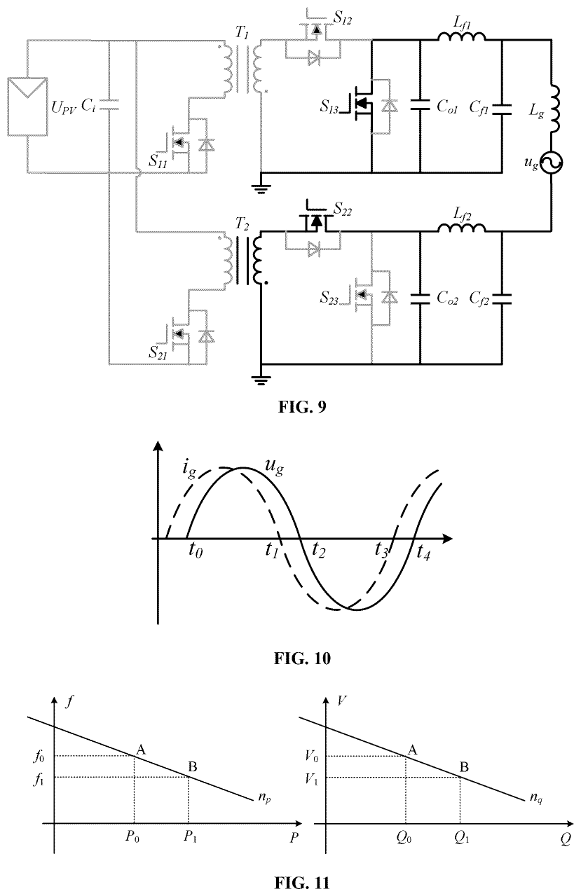

With reference to FIG. 1 to FIG. 9, a first example of the present disclosure is shown. The example provides a grid-forming microinverter method based on bidirectional flyback converters. The method includes the bidirectional flyback converters and a grid-forming microinverter. The grid-forming microinverter includes a power loop, a voltage loop, and a peak current control loop. The method includes:

S1: active power and reactive power are calculated through an output voltage and an output current of the grid-forming microinverter.

Specifically, the power loop includes an active power-frequency droop link and a reactive power-voltage droop link, and a related formula is as follows:

$$\{ \begin{matrix}{ω}_{ref} - ω = {n}_{p} ( {P}_{ref} - {p}_{e} ) \\ {U}_{ref} - {U}_{0} = {n}_{q} ( {Q}_{ref} - {q}_{e} ) \\ {u}_{ref} = \sqrt{2} {U}_{0} cos ( ω t )\end{matrix}$$

where nₚ is an active power droop coefficient, n_{q} is a reactive power droop coefficient, ω_{ref} is a reference value of an output voltage frequency of the microinverter, ω is the output voltage frequency of the microinverter, P_{ref} and Q_{ref} are preset power reference values, pₑ is the output active power of the microinverter, u_{ref} is a reference voltage of the voltage loop, U_{ref} is a reference voltage amplitude value of the voltage loop, U₀ is the output voltage of the grid-forming microinverter, qₑ is the output reactive power of the microinverter, and t is time.

Further, a core of the controller is the power loop composed of droop control. The power loop controls the voltage and the frequency of the microinverter by detecting an active component and a reactive component of the output power and simulating droop characteristics of a synchronous generator in a traditional power system.

Further, in a weak grid environment, since power grid impedance cannot be omitted, it is usually regarded as an inductance with a large inductance value. A specific formula of power transmission characteristics of the microinverter in this case is as follows:

$$\{ \begin{matrix}p = \frac{{U}_{inv} {U}_{g} sin δ}{{X}_{g}} \\ q = \frac{{U}_{inv}^{2} - {U}_{inv} {U}_{g} cos δ}{{X}_{g}}\end{matrix}$$

where p is the output active power of the microinverter, Uᵢₙᵥ is an output root mean square voltage of the microinverter, U_{g} is a root mean square voltage of a power grid, δ is a phase difference between the output voltage of the microinverter and the voltage of the power grid, and X_{g} is the power grid impedance.

Specifically, the output active power of the microinverter is linearly related to the frequency. The output reactive power is linearly related to an amplitude of the output voltage. Since a power angle is usually small, a specific formula for the power transmission characteristics of the microinverter is approximated as follows:

$$\{ \begin{matrix}p \approx \frac{{U}_{inv} {U}_{g}}{{X}_{g}} {ω}_{inv} t \\ q \approx \frac{{U}_{inv} - {U}_{g}}{{X}_{g}} {U}_{inv}\end{matrix}$$

where p is the output active power of the microinverter, q is the output reactive power of the microinverter, Uᵢₙᵥ is the output root mean square voltage of the microinverter, U_{g} is the root mean square voltage of the power grid, X_{g} is the power grid impedance, ωᵢₙᵥ is an angular frequency of the output voltage of the inverter, and t is the time.

S2: a reference signal of the voltage loop is generated by using a preset power reference value based on control of the power loop.

Specifically, the voltage loop obtains a voltage error signal by comparing a voltage reference value generated by the power loop with the actual output voltage. The obtained voltage error signal is processed by a proportional-integral-derivative (PID) controller, and a primary-side current reference signal of the peak current control loop is generated.

Further, the peak current control loop compares the primary-side current reference signal generated by the voltage loop with the primary-side current signals of the first bidirectional flyback converter and the second bidirectional flyback converter. Primary-side switch tubes of the first bidirectional flyback converter and the second bidirectional flyback converter are turned off in a case where the primary-side current signals of the first bidirectional flyback converter and the second bidirectional flyback converter are greater than or equal to primary-side current reference signals of the first bidirectional flyback converter and the second bidirectional flyback converter. The primary-side switch tubes of the first bidirectional flyback converter and the second bidirectional flyback converter are turned on in a case where the primary-side current signals of the first bidirectional flyback converter and the second bidirectional flyback converter are less than the primary-side current reference signals of the first bidirectional flyback converter and the second bidirectional flyback converter, to generate the drive signals for the switch tubes of the first bidirectional flyback converter and the second bidirectional flyback converter.

Furthermore, the grid-forming microinverter generates a voltage phase of a power grid through a power control loop, to achieve synchronization between the microinverter and the power grid, and guarantee stable operation of a system.

S3: a reference signal of the peak current control loop is generated under control of the voltage loop according to an actual output voltage.

S4: according to primary-side current signals of the first bidirectional flyback converter and the second bidirectional flyback converter, a drive signal for each switch tube is generated under regulation of the peak current control loop.

Specifically, the first bidirectional flyback converter and the second bidirectional flyback converter work in an inductive current continuous mode. In a case where the first bidirectional flyback converter works, a circuit is divided into a mode I and a mode II according to an off state of the third switch tube and an off state of the sixth switch tube.

Further, a photovoltaic direct-current input power supply transmits energy to a primary side of the first flyback transformer. A secondary side of the first flyback transformer does not work. In this case, a current of the power grid completes freewheeling by turning on anti-parallel diodes of the third switch tube and the sixth switch tube. Assuming that turn-on time is T₁, a related formula of the mode I is as follows:

$${i}_{1 m} = \frac{{U}_{DC}}{{L}_{m 1}} {T}_{1} + {i}_{10}$$

where Lₘ₁ is an inductance value of a primary winding of a first flyback transformer, i₁₀ is an initial value of a primary-side current of the first flyback transformer, T₁ is a turn-on time length of a primary-side switch tube of the first bidirectional flyback transformer in one switching cycle, U_{DC} is a direct-current input voltage, and i₁ₘ is a current peak value of the primary-side current of the first flyback transformer in one switching cycle.

Furthermore, the secondary side of the first flyback transformer transmits energy to the power grid, and the primary side of the first flyback transformer does not work. Assuming that turn-off time is T₂, a related formula of the mode II is as follows:

$${i}_{2 m} = {i}_{20} - \frac{{u}_{o}}{{L}_{m 2}} {T}_{2}$$

where Lₘ₂ is an inductance value of a secondary winding of the first flyback transformer, i₂₀ is an initial value of a secondary-side current of the first flyback transformer, T₂ is a turn-off time length of the primary-side switch tube of the first bidirectional flyback transformer in one switching cycle, u₀ is the actual output voltage, and i₂ₘ is a current peak value of a secondary-side current of the first flyback transformer in one switching cycle.

Further, a specific formula of an equivalent inductance value on a second winding of the transformer is as follows:

$${L}_{m 2} = ( {L}_{m 1} {N}_{2}^{2} ) / {N}_{1}^{2}$$

where N₁ is a number of turns of the primary winding of the first bidirectional flyback transformer, and N₂ is a number of turns of the secondary winding of the first bidirectional flyback transformer.

Specifically, in a case where the second bidirectional flyback converter works, the circuit is divided into a mode III and a mode IV according to the off state of the sixth switch tube and an on state of the third switch tube.

Further, in the mode III, the photovoltaic direct-current input power supply transmits energy to a primary side of the second bidirectional flyback transformer. A secondary side of the second bidirectional flyback transformer does not work. In this case, the current of the power grid completes freewheeling by turning on the anti-parallel diodes of the third switch tube and the sixth switch tube. Assuming that turn-on time of the primary-side switch tube of the second bidirectional flyback transformer is T₃, a related formula of the mode III is as follows:

$${i}_{3 m} = \frac{{U}_{DC}}{{L}_{m 3}} {T}_{3} + {i}_{30}$$

where Lₘ₃ is an inductance value of a primary winding of a second bidirectional flyback transformer, i₃₀ is an initial value of a primary-side current of the second bidirectional flyback transformer, T₃ is a turn-on time length of a primary-side switch tube of the second bidirectional flyback transformer in one switching cycle, U_{DC} is a direct-current input voltage, and i₃ₘ is a current peak value of the primary-side current of the second bidirectional flyback transformer in one switching cycle.

Furthermore, in the mode IV, the fourth switch tube is turned off, and the fifth switch tube is turned on. The secondary side of the second bidirectional flyback transformer transmits energy to the power grid, and the primary side of the second bidirectional flyback transformer does not work. A related formula of the mode IV is as follows:

$${i}_{4 m} = {i}_{40} - \frac{{u}_{o}}{{L}_{m 4}} {T}_{4}$$

where Lₘ₄ is an inductance value of a secondary winding of the second bidirectional flyback transformer, i₄₀ is an initial value of a secondary-side current of the second bidirectional flyback transformer, T₄ is a turn-off time length of the primary-side switch tube of the second bidirectional flyback transformer in one switching cycle, u₀ is the actual output voltage, and i₄ₘ is a current peak value of a secondary-side current of the second flyback transformer in one switching cycle.

Further, the example further provides a grid-forming microinverter based on bidirectional flyback converters. The grid-forming microinverter includes a photovoltaic direct-current input source, an input filter capacitor, a first bidirectional flyback transformer, a second bidirectional flyback transformer, a first switch tube, a second switch tube, a third switch tube, a fourth switch tube, a fifth switch tube, a sixth switch tube, a first output capacitor, a second output capacitor, a first output filter inductor, a second output filter inductor, a first output filter capacitor, a second output filter capacitor, a grid-side inductor, an equivalent power grid, and the grid-forming microinverter.

Specifically, a positive terminal of the input filter capacitor is electrically connected to a positive terminal of the photovoltaic direct-current input source, a primary side of the first bidirectional flyback transformer, and a primary side of the second bidirectional flyback transformer. A negative terminal of the input filter capacitor is electrically connected to a negative terminal of the direct-current input source, a source of the first switch tube, and a source of the fourth switch tube. The other end of the primary side of the first bidirectional flyback transformer is electrically connected to a drain of the first switch tube. One end of a secondary side of the first bidirectional flyback transformer is electrically connected to a source of the second switch tube. The other end of the secondary side of the first bidirectional flyback transformer is electrically connected to a source of the third switch tube, a negative terminal of the first output capacitor, and a negative terminal of the first output filter capacitor. The source of the second switch tube is electrically connected to the source of the third switch tube, a positive terminal of the first output capacitor, and one end of the first output filter inductor. The other end of the first output filter inductor is electrically connected to a positive terminal of the first output filter capacitor and one end of the grid-side inductor. The other end of the grid-side inductor is electrically connected to one end of the equivalent power grid.

Further, the other end of the primary side of the second bidirectional flyback transformer is electrically connected to a drain of the fourth switch tube. One end of a secondary side of the second bidirectional flyback transformer is electrically connected to a source of the fifth switch tube. The other end of the secondary side of the second bidirectional flyback transformer is electrically connected to a source of the sixth switch tube, a negative terminal of the second output capacitor, and a negative terminal of the second output filter capacitor. The source of the fifth switch tube is electrically connected to the source of the sixth switch tube, a positive terminal of the second output capacitor, and one end of the second output filter inductor. The other end of the second output filter inductor is electrically connected to a positive terminal of the second output filter capacitor and the other end of the equivalent power grid.

Furthermore, a drive signal of the first switch tube and drive signals of the second switch tube, the fourth switch tube, the fifth switch tube, the third switch tube, and the sixth switch tube are complementary separately. Working states of the first bidirectional flyback converter and the second bidirectional flyback converter are completely symmetrical. The first bidirectional flyback converter works in a positive half cycle of a voltage of a power grid. The second bidirectional flyback converter works in a negative half cycle of the voltage of the power grid.

The present example further provides a computer device, applicable to a case of the grid-forming microinverter based on bidirectional flyback converters. The computer device includes a memory and a processor. The memory is configured to store computer-executable instructions. The processor is configured to execute the computer-executable instructions to implement the grid-forming microinverter based on bidirectional flyback converters as proposed in the above example.

The computer device may be a terminal. The computer device includes a processor, a memory, a communication interface, a display screen, and an input apparatus which are connected through a system bus. The processor of the computer device is configured to provide calculation and control capacities. The memory of the computer device includes a non-volatile storage medium and an internal memory. The non-volatile storage medium stores an operation system and a computer program. The internal memory provides an execution environment for the operation system and the computer program in the nonvolatile storage medium. The communication interface of the computer device is configured to communicate with an external terminal in a wired or wireless manner. The wireless manner can be implemented through wireless fidelity (Wi-Fi), a carrier network, a near field communication (NFC), etc. The display screen of the computer device may be a liquid crystal display screen or an electronic ink display screen. The input apparatus of the computer device may be a touch layer covered with the display screen, or a key, a trackball, or a touch pad arranged on a housing of the computer device, or an external keyboard, a touch pad, or a mouse.

The example of the present disclosure further provides a storage medium. The storage medium stores a computer program. The program, when executed by a processor, implements the following steps: the bidirectional flyback converters and a grid-forming microinverter are provided. The controller includes a power loop, a voltage loop, and a peak current control loop. Active power and reactive power are calculated through an output voltage and an output current of the grid-forming microinverter. A reference signal of the voltage loop is generated by using a preset power reference value based on control of the power loop. A reference signal of the peak current control loop is generated under control of the voltage loop according to an actual output voltage. According to primary-side current signals of the first bidirectional flyback converter and the second bidirectional flyback converter, a drive signal for each switch tube is generated under regulation of the peak current control loop.

In summary, according to the present disclosure, a voltage phase of a power grid is directly generated through a power loop, no phase locked loop link is needed, and stable operation can be maintained under a weak grid environment. Moreover, a topology of a bidirectional structure is used. A topological structure is simple, cost is low, efficiency is high, and control complexity is low. Bidirectional flow of power is implemented. An output power factor may also regulated. Reactive power support is provided for the power grid.

### Embodiment 2

With reference to FIG. 10 to FIG. 14, a second example of the present disclosure is provided. The example provides a grid-forming microinverter based on bidirectional flyback converters. In order to verify the beneficial effects of the present disclosure, scientific demonstration is carried out through economic benefit calculation and simulation experiment.

Specifically, the grid-forming microinverter based on bidirectional flyback converters includes a photovoltaic direct-current input source U_{PV}, an input filter capacitor Cᵢ, a first bidirectional flyback transformer T₁, a second bidirectional flyback transformer T₂, a first switch tube S₁₁, a second switch tube S₁₂, a third switch tube S₁₃, a fourth switch tube S₂₁, a fifth switch tube S₂₂ a sixth switch tube S₂₃, a first output capacitor Cₒ₁, a second output capacitor Cₒ₂, a first output filter inductor L_{f1}, a second output filter inductor L_{f2}, a first output filter capacitor C_{f1}, a second output filter capacitor C_{f2}, a grid-side inductor L_{g}, an equivalent power grid u_{g}, and a controller.

Further, as shown in FIG. 10, during a period t₀ to t₁, the first bidirectional flyback converter works in an inductive current continuous mode, and the second bidirectional flyback converter does not work. The sixth switch tube is turned on, and the third switch tube is turned off. A circuit may be divided into two modes according to the on state and the off state of the first switch tube and the second switch tube.

Further, during a period t₁ to t₂, the voltage and the current of the power grid reverse, power flows from the power grid to the first bidirectional flyback converter. In this case, the first bidirectional flyback converter still works in an inductive current continuous mode, and the second bidirectional flyback converter does not work. The sixth switch tube is turned on, and the third switch tube is turned off. The working modes in this period are still the mode I and the mode II in the period t₀ to t₁, but a power flow direction changes.

Specifically, during a period t₂ to t₃, the voltage and the current of the power grid are in a same direction, and are in a negative half cycle. In this case, the second bidirectional flyback converter works in an inductive current continuous mode, and the first bidirectional flyback converter does not work. The third switch tube is turned on, and the sixth switch tube is turned off. The circuit may be divided into two modes according to the on state and the off state of the fourth switch tube and the fifth switch tube. It should be noted that mode analysis for the circuit in this period is completely symmetrical with the period t₀ to t₁, except that the first bidirectional flyback converter is changed to the second bidirectional flyback converter.

Further, during a period t₃ to t₄, the voltage and the current of the power grid reverse, power flows from the power grid to the second bidirectional flyback converter. In this case, the second bidirectional flyback converter still works in an inductive current continuous mode, and the first bidirectional flyback converter does not work. The third switch tube is turned on, and the sixth switch tube is turned off. The working modes in the period are still the mode III and the mode IV in the period t₂ to t₃, but a power flow direction changes. Further, to is a zero-crossing point of the voltage of the power grid from a negative half cycle to a positive half cycle; t₁ is a zero-crossing point of a grid-connected current from a positive half cycle to a negative half cycle; t₂ is a zero-crossing point of the voltage of the power grid from a positive half cycle to a negative half cycle; t₃ is a zero-crossing point of the grid-connected current from a negative half cycle to a positive half cycle; and t₄ is a zero-crossing point of the voltage of the power grid from a negative half cycle to a positive half cycle at the beginning of a next cycle.

Further, as shown in FIG. 11, when the microinverter outputs active power being P₀ and reactive power being Q₀, the microinverter outputs a voltage with a frequency being f₀ and an amplitude being V₀, that is, operates at a rated operating point A of a droop characteristic curve. When the microinverter outputs active power being P₁ and reactive power being Q₁, the microinverter outputs a voltage with a frequency being f₁ and an amplitude being V₁, that is, operates at a point B of the droop characteristic curve. In summary, droop control can adjust a phase and an amplitude of the output voltage of the microinverter through the power loop control principle, and then adjust the output active power and reactive power.

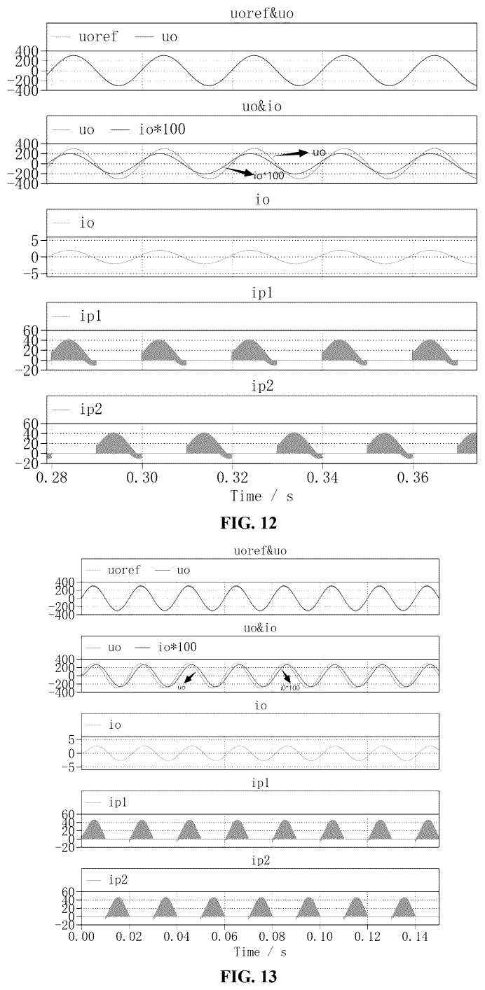

Specifically, a simulation model of the grid-forming microinverter based on bidirectional flyback converters is built by PLECS software for verification. FIG. 12 shows output voltage and current waveform parameters when leading power factors are output. A photovoltaic direct-current input voltage is 48 V, and a switching frequency of the bidirectional flyback converters is 100 kHz. Moreover, in order to simulate a weak grid environment, a grid-side inductor value is taken as 30 mH. As shown in FIG. 13, the output current of the microinverter exceeds the output voltage, and the active power and the capacitive reactive power are output to the power grid.

Furthermore, the grid-forming microinverter based on bidirectional flyback converters can work at any output power factor, to implement reactive power support for a weak power grid. Moreover, since the grid-forming microinverter based on bidirectional flyback converters is a single-stage topology, it does not need a direct-current bus electrolytic capacitor, such that cost, a size and reliability are improved.

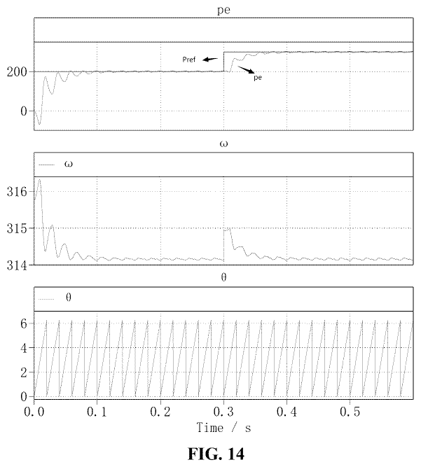

Further, as shown in FIG. 14, it can be seen that when an active power reference value changes from 200 W to 300 W, the active power output by the microinverter can better track the active power reference value, and the output voltage phase θ of the microinverter can be generated without a phase-locked loop, to implement synchronization with the voltage of the power grid.

It should be noted that the above examples are merely used to explain the technical solutions of the present disclosure and are not intended to limit the present disclosure. Although the present disclosure is described in detail with reference to the preferred examples, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the claims of the present disclosure.

What is claimed is:

1. A grid-forming microinverter method based on bidirectional flyback converters, comprising the bidirectional flyback converters and a grid-forming microinverter, wherein
the grid-forming microinverter comprises a power loop, a voltage loop, and a peak current control loop; and
the method comprises: calculating active power and reactive power through an output voltage and an output current of the grid-forming microinverter;
generating a reference signal of the voltage loop by using a preset power reference value based on a power loop control principle;
generating a reference signal of the peak current control loop under control of the voltage loop according to an actual output voltage; and
generating, according to primary-side current signals of the first bidirectional flyback converter and the second bidirectional flyback converter, a drive signal for each switch tube under regulation of the peak current control loop.

2. The grid-forming microinverter method based on bidirectional flyback converters according to claim 1, wherein the generating a reference signal of the voltage loop by using a preset power reference value comprises:
obtaining, by the voltage loop, a voltage error signal by comparing a voltage reference value generated by the power loop with the actual output voltage;
processing the obtained voltage error signal by a proportional-integral-derivative (PID) controller, and generating a primary-side current reference signal of the peak current control loop;
comparing, by the peak current control loop, the primary-side current reference signal generated by the voltage loop with the primary-side current signals of the first bidirectional flyback converter and the second bidirectional flyback converter;
turning off primary-side switch tubes of the first bidirectional flyback converter and the second bidirectional flyback converter in a case where the primary-side current signals of the first bidirectional flyback converter and the second bidirectional flyback converter are greater than or equal to primary-side current reference signals of the first bidirectional flyback converter and the second bidirectional flyback converter;
turning on the primary-side switch tubes of the first bidirectional flyback converter and the second bidirectional flyback converter in a case where the primary-side current signals of the first bidirectional flyback converter and the second bidirectional flyback converter are less than the primary-side current reference signals of the first bidirectional flyback converter and the second bidirectional flyback converter, to generate the drive signals for the switch tubes of the first bidirectional flyback converter and the second bidirectional flyback converter; and
generating, by the grid-forming microinverter, a voltage phase of a power grid through a power control loop, to achieve synchronization between the microinverter and the power grid, and guarantee stable operation of a system.

3. The grid-forming microinverter method based on bidirectional flyback converters according to claim 2, wherein the power loop comprises an active power-frequency droop link and a reactive power-voltage droop link, and a related formula is as follows:
$$\{ \begin{matrix}{ω}_{ref} - ω = {n}_{p} ( {P}_{ref} - {p}_{e} ) \\ {U}_{ref} - {U}_{0} = {n}_{q} ( {Q}_{ref} - {q}_{e} ) \\ {u}_{ref} = {U}_{ref} cos ( ω t )\end{matrix}$$
wherein nₚ is an active power droop coefficient, n_{q} is a reactive power droop coefficient, ω_{ref} is a reference value of an output voltage frequency of the microinverter, ω is the output voltage frequency of the microinverter, P_{ref} and Q_{ref} are preset power reference values, pₑ is the output active power of the microinverter, u_{ref} is a reference voltage of the voltage loop, U_{ref} is a reference voltage amplitude value of the voltage loop, U₀ is the output voltage of the microinverter, qₑ is the output reactive power of the microinverter, and t is time.

4. The grid-forming microinverter method based on bidirectional flyback converters according to claim 2, wherein the generating, according to primary-side current signals of the first bidirectional flyback converter and the second bidirectional flyback converter, a drive signal for each switch tube under regulation of the peak current control loop comprises:
making the first bidirectional flyback converter and the second bidirectional flyback converter work in an inductive current continuous mode;
dividing, in a case where the first bidirectional flyback converter works, a circuit into a mode I and a mode II according to an off state of the third switch tube and an off state of the sixth switch tube; and
dividing, in a case where the second bidirectional flyback converter works, the circuit into a mode III and a mode IV according to the off state of the sixth switch tube and an on state of the third switch tube.

5. The grid-forming microinverter method based on bidirectional flyback converters according to claim 4, wherein a relevant formula of the mode I is as follows:
$${i}_{1 m} = \frac{{U}_{DC}}{{L}_{m 1}} {T}_{1} + {i}_{10}$$
wherein Lₘ₁ is an inductance value of a primary winding of a first flyback transformer, i₁₀ is an initial value of a primary-side current of the first flyback transformer, T₁ is a turn-on time length of a primary-side switch tube of the first bidirectional flyback transformer in one switching cycle, U_{DC} is a direct-current input voltage, and i₁ₘ is a current peak value of the primary-side current of the first flyback transformer in one switching cycle; and
a related formula of the mode II is as follows:
$${i}_{2 m} = {i}_{20} - \frac{{u}_{o}}{{L}_{m 2}} {T}_{2}$$
wherein Lₘ₂ is an inductance value of a secondary winding of the first flyback transformer, i₂₀ is an initial value of a secondary-side current of the first flyback transformer, T₂ is a turn-off time length of the primary-side switch tube of the first bidirectional flyback transformer in one switching cycle, u₀ is the actual output voltage, and i₂ₘ is a current peak value of a secondary-side current of the first flyback transformer in one switching cycle.

6. A grid-forming microinverter based on bidirectional flyback converters, based on the grid-forming microinverter method based on bidirectional flyback converters according to claim 5, comprising a photovoltaic direct-current input source, an input filter capacitor, a first bidirectional flyback transformer, a second bidirectional flyback transformer, a first switch tube, a second switch tube, a third switch tube, a fourth switch tube, a fifth switch tube, a sixth switch tube, a first output capacitor, a second output capacitor, a first output filter inductor, a second output filter inductor, a first output filter capacitor, a second output filter capacitor, a grid-side inductor, an equivalent power grid, and the grid-forming microinverter.

7. The grid-forming microinverter based on bidirectional flyback converters according to claim 6, wherein a positive terminal of the input filter capacitor is electrically connected to a positive terminal of the photovoltaic direct-current input source, a primary side of the first bidirectional flyback transformer, and a primary side of the second bidirectional flyback transformer; a negative terminal of the input filter capacitor is electrically connected to a negative terminal of the direct-current input source, a source of the first switch tube, and a source of the fourth switch tube; the other end of the primary side of the first bidirectional flyback transformer is electrically connected to a drain of the first switch tube; one end of a secondary side of the first bidirectional flyback transformer is electrically connected to a source of the second switch tube; the other end of the secondary side of the first bidirectional flyback transformer is electrically connected to a source of the third switch tube, a negative terminal of the first output capacitor, and a negative terminal of the first output filter capacitor; the source of the second switch tube is electrically connected to the source of the third switch tube, a positive terminal of the first output capacitor, and one end of the first output filter inductor; the other end of the first output filter inductor is electrically connected to a positive terminal of the first output filter capacitor and one end of the grid-side inductor; and the other end of the grid-side inductor is electrically connected to one end of the equivalent power grid.

8. The grid-forming microinverter based on bidirectional flyback converters according to claim 7, wherein the other end of the primary side of the second bidirectional flyback transformer is electrically connected to a drain of the fourth switch tube, one end of a secondary side of the second bidirectional flyback transformer is electrically connected to a source of the fifth switch tube; the other end of the secondary side of the second bidirectional flyback transformer is electrically connected to a source of the sixth switch tube, a negative terminal of the second output capacitor, and a negative terminal of the second output filter capacitor; the source of the fifth switch tube is electrically connected to the source of the sixth switch tube, a positive terminal of the second output capacitor, and one end of the second output filter inductor; and the other end of the second output filter inductor is electrically connected to a positive terminal of the second output filter capacitor and the other end of the equivalent power grid.

9. The grid-forming microinverter based on bidirectional flyback converters according to claim 6, wherein a drive signal of the first switch tube and drive signals of the second switch tube, the fourth switch tube, the fifth switch tube, the third switch tube, and the sixth switch tube are complementary separately.

10. The grid-forming microinverter based on bidirectional flyback converters according to claim 6, wherein working states of the first bidirectional flyback converter and the second bidirectional flyback converter are completely symmetrical, the first bidirectional flyback converter works in a positive half cycle of a voltage of a power grid, and the second bidirectional flyback converter works in a negative half cycle of the voltage of the power grid.
